(19) United States
(12) Patent Application Publication
(10) Pub. No.: US 2025/0172760 A1
(43) Pub. Date: May 29, 2025

(54) FIBER ARRAY WITH SIDE POLISHING FOR IMPROVED FIBER POSITION WITH WAFER SUBSTRATE OR CHIP

(71) Applicant: ADVANCED MICRO FOUNDRY PTE. LTD., Singapore (SG)

(72) Inventors: Wu XIE, Singapore (SG); Xianshu LUO, Singapore (SG); Guo-Qiang LO, Singapore (SG)

(73) Assignee: ADVANCED MICRO FOUNDRY PTE. LTD., Singapore (SG)

(21) Appl. No.: 18/726,885

(22) PCT Filed: Feb. 28, 2022
(86) PCT No.: PCT/SG2022/050095

§ 371 Date: Jul. 5, 2024

(51) Int. Cl. G02B 6/36

(52) U.S. Cl. CPC G02B 6/3636

(57) ABSTRACT

A fiber array for edge coupling of at least one optical fiber with at least one wafer substrate is provided. The fiber array includes an optical fiber core; a cladding covering the optical fiber core; a V-groove mount at the top of the cladding; and a polished and tapered lid at the bottom of the cladding.

FIG. 4 accompanies the abstract.

### TECHNICAL FIELD

The present embodiment generally relates to photonic integrated circuits (PICs) and more particularly to coupling optical fiber components with silicon photonics in PICs.

### BACKGROUND

A photonic integrated circuit (PIC), also termed as integrated optical circuit, or planar lightwave circuits are devices on which many optical and electronic components are integrated. The PICs are fabricated using lithography on substrates of silicon, silica, or at times, nonlinear crystal material including lithium niobate. The PICS contain a number of arrays of identical components with main application in optical fiber communications, optical sensors and metrology.

Mostly, substrate material determines features and limitations of PICs e.g., silica-on-silicon integrated optics builds on silicon wafers. Silica waveguides allow realisation of couplers and filters, splitters, and combiners. They may also include active elements with optical gain connected with optical fibers. One method for having coupling multiple waveguides is to use fiber arrays. In some, photonic functions are directly implemented on chips. The silicon nitride (Si3N4) platform has also been used to make photonic devices that operate in the 1-μm spectral region or even at shorter wavelengths.

Waveguides are also fabricated on silica glass such as fused silica glass such that waveguides are fabricated far below surface to form embedded waveguides enabling three-dimensions circuit designs. Yet another material used as substrate is Lithium niobate (LiNbO3) as a nonlinear crystal material that is suitable for devices performing nonlinear functions, for example electro-optic modulators or acousto-optic transducers.

In complex optical transmission systems, optical interconnects between fiber and the PICs happen frequently in the whole system, so efficient fiber-to-chip coupling is of critical importance. However, size difference between substrate waveguide and fiber diameter leads to complex challenges. For example, the feature size of a silicon waveguide is as small as tens of nanometres whereas the typical diameter of a single mode fiber (SMF) is around 125 μm with a core diameter near 10 μm, thus leading to a major size mismatch between a fiber core and the Si waveguide, causing considerable optical transmission loss when light emitting from the fiber core enters the Si waveguide directly. Fiber-to-chip couplers are a type of key photonic component to deal with this issue in optical interconnects. Generally, there are two methods of fiber-to-chip coupling, vertical coupling (or off-plane coupling) and butt coupling (or edge coupling/in-plane coupling), depending on the relative position of fiber and photonic chip. In edge coupling, the fiber is typically placed at a wafer facet and is aligned with the Si waveguides horizontally, edge couplers are commonly applied. Edge couplers achieve high coupling efficiency, broad bandwidth, and polarization independence, but they also have some limitations including relatively a larger footprint than grating couplers, fixed coupling position, and more strict requirements of the coupling facet.

For telecom and datacom applications, the transfer of optical signals to/from the PIC requires some type of Fiber-to-PIC coupling. Edge-coupling is one option which can provide low insertion-loss (IL), large spectral bandwidth (BW), and low-sensitivity to polarization. However, in current standard edge-coupling prepared Si-PIC, a deep-trench etching is applied to form a high-quality optical interface for edge coupling, the process forms a protruding portion which will induce a 20-50μm gap between the fiber core to edge coupler. This gap causes high optical power loss. In order to bypass the impact of the protruding portion, several solutions have been proposed. One of the solutions include a fiber that is longitudinally located to extend the fiber out of V-groove. However, this is a complex process and thus also do not provide any way to ensure fiber end roughness as fiber end polishing cannot be applied coupled with issues pertaining to stability. Yet another solution includes to remove the bottom fiber array lid for fiber array assembly. However, the removal of the lid leads to a loose fiber position and epoxy thickness control thus leading process complexity and costs.

In a standard fiber array for optical alignment, as shown in FIG. 1, there is a 20-50 μm gap between the fiber core and the edge coupler of the PIC, causing high optical loss. For Example, the edge coupler can comprise silicon oxide, Si substrate and a portion of the Si substrate that extends towards the fiber array lid. However, increasing the trench depth in order for the fiber to move in will cause the wafer to become fragile and easy to break.

FIG. 2 depicts a fiber array extending out of the V-groove to reduce the aforementioned gap. However, extending the fiber out of the V-groove requires a complex process control to form such a structure, and is difficult to avoid damage or increase roughness to the fiber end face during formation. V-grooves are monolithically integrated with PICs enable low loss edge coupling with passive alignment to single fibers or fiber arrays.

FIG. 3 depicts a fiber array without a bottom lid for optical alignment of the fiber with the waveguide. However, the fiber array without a bottom lid is difficult to fabricate which increases the process complexity. This arrangement is also difficult to control the epoxy thickness due to the looser fiber positioning without the bottom lid.

Thus, finding a cost-effective solution to address the problem of fiber-to-chip optical interconnection in silicon photonics is critical, since fiber port counts per chip increases. As mentioned, the problem to solve is the optical mode size mismatch between the silicon photonics chip wave guides and optical fibers.

Accordingly, there remains a need for a solution to mitigate the fiber array to Si-PIC positioning impact caused by protruding portions from the etching process in the edge coupling regime.

### SUMMARY

In a first aspect, there is provided a fiber array for edge coupling of at least one optical fiber with at least one wafer substrate, the fiber array comprising: an optical fiber core; a fiber cladding covering the optical fiber core; a V-groove mount at the top of the fibre cladding; and a polished and tapered fiber array lid at the bottom of the fiber cladding.

In one embodiment of the first aspect, the optical fiber core is single mode.

In one embodiment of the first aspect, the optical fiber core is multimode.

In one embodiment of the first aspect, the fiber array lid is made up of polymer.

In a second aspect, there is provided a photonic integrated circuit comprising: a wafer substrate; a fiber array described herein in-plane and coupled with the wafer substrate.

In one embodiment of the second aspect, the optical fiber core is single mode.

In one embodiment of the second aspect, the optical fiber core is multimode.

In one embodiment of the second aspect, the fiber array lid is made up of polymer.

In one embodiment of the second aspect, V-groove arrays are fabricated on separate silicon sub-mounts and are then edge coupled to the wafer substrate by active alignment.

In one embodiment of the second aspect, the wafer substrate comprises a deep trench structure, and the fiber array is aligned above the deep trench structure, the alignment including angle and position of the fiber array lid, wherein the angle of the fiber array lid is predetermined by a depth of the deep trench structure.

In a third aspect, there is provided a method of manufacturing the photonic integrated circuit disclosed herein, the method comprising;
a) a step of etching a silicon substrate of the wafer substrate to form a deep trench structure such that the deep trench structure forms the optical interface for edge coupling;
b) a step of performing a first polishing of a fiber array lid to form the polished and tapered fiber array lid aligned with the wafer substrate and above the deep trench structure; and
c) a step of performing a second polishing of the above polished and tapered fiber array lid to place the polished and tapered fiber array lid in proximity with the silicon oxide substrate.
d) In a further step, the fiber core is adjusted in proximity with the silicon oxide to achieve a good optical interconnection between fiber array and wafer substrate.

In one embodiment of the third aspect, an angle of the polished and tapered fiber array lid is about 30° to 45°.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The other objects, features and advantages will occur to those skilled in the art from the following description of the preferred embodiment and the accompanying drawings in which:

FIG. 1 depicts a standard fiber array-based photonics integrated circuit;

FIG. 2 depicts a fiber array with extension-based photonics integrated circuits;

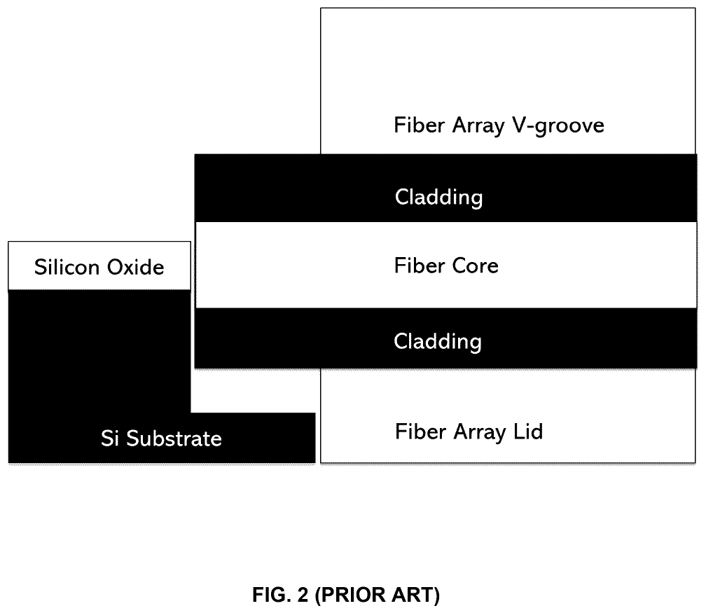

FIG. 3 depicts a fiber array without a bottom lid-based photonics integrated circuit; and

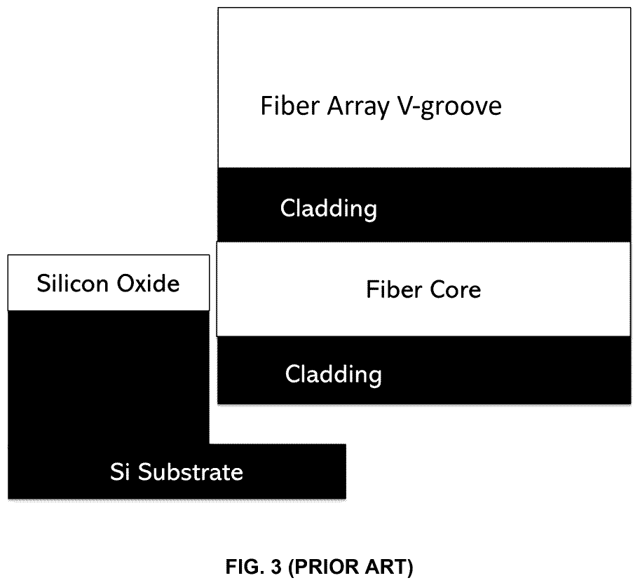

FIG. 4 depicts a fiber array with a polished and tapered lid to couple fiber with a wafer substrate to form a photonics integrated circuit, according to an embodiment herein.

### DETAILED DESCRIPTION OF PREFERRED EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

As provided in the foregoing, the standard fiber arrays for coupling optical fiber with wafer waveguide or substrate waveguide still possess several limitations. The present invention and disclosure herein overcome said limitations by providing a fiber array with a polished and tapered lid to couple optical fiber with a wafer substrate or chip.

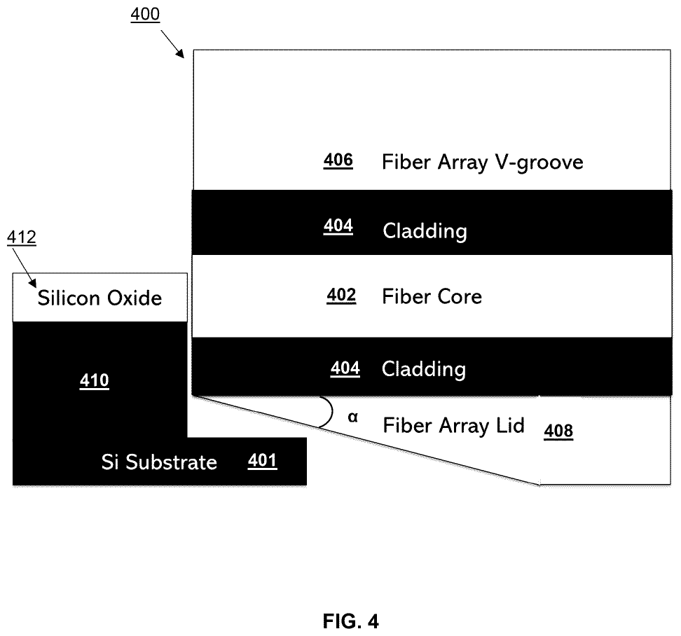

The fiber array 400 of FIG. 4 includes a fiber core 402, a fiber cladding 404, a fiber array V-groove mounts 406, and a tapered fiber array lid 408. The fiber core 402 can be wrapped in the fiber cladding 404 and is held in three-point contact to the two V-groove sidewalls 406, the tapered and angled fiber array lid 408. The bottom fiber array lid 408 can be made up of a polymer. The fiber core 402 can be surrounded by the fiber cladding 404, such that the array comprises two layers of cladding 404 either side of said fiber core 402.

In an aspect, the fiber core 402 can be a single mode fiber. In another embodiment, the fiber core 402 can be a multimode fiber. In an embodiment, the fiber array lid 408 can have a thickness of at least about 200 um and gradually tapers towards the edge of cladding layer 404 as it approaches the wafer substrate 410 as shown in FIG. 4.

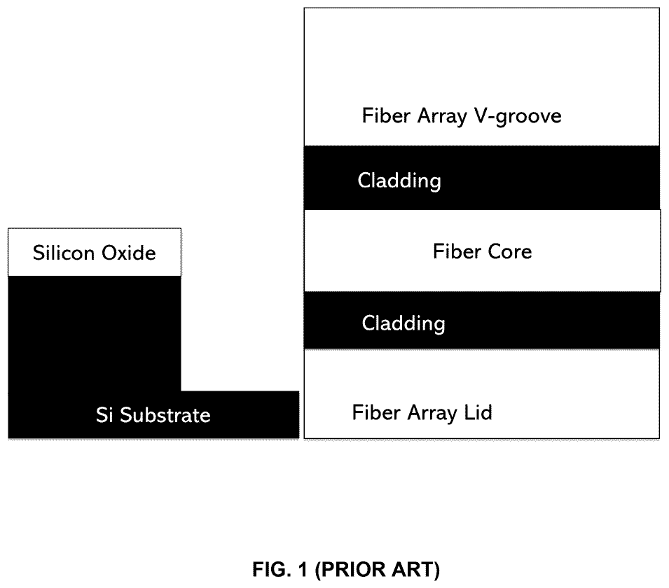

In an aspect, an angle polishing for fiber array lid 408 may be performed based on the customary methods according to standard Fiber Array shown in FIG. 1, The angle α and front-end Lid remnant need to be controlled to ensure the fiber core 402 is in proximity with the silicon oxide 412 of the edge coupler. In one embodiment, the “proximity” can refer to the inclusion of a space or gap there between. In one embodiment, the said gap may be zero such that the fiber core and silicon xoide are abutting and in contact with each other.

In one embodiment, the angle α can be about 45° and can be varied to about 30°, thus the angle α can range from about 30° to 45° relative to the plane and horizontal lower surface of the bottom cladding layer 404.

The tapering of the fiber array lid 408 can be achieved by polishing the fiber array lid 408 to a certain angle to enable the fiber array to be placed next to close to the edge coupler. The angle of polishing is pre-determined by the deep trench depth of layer 410, and thus position of fiber array is controlled by deep trench bottom stage.

In an aspect, the polishing can lead to the tapering angle being about 45° and can be varied to about 30° to allow some height tolerance.

The fabrication of the fiber array 400 of FIG. 4 can be compatible with current mature fiber array assembly processes and related controls while offering enhanced stability and alignment precision.

The wafer substrate 410 can be composed of a silicon substrate layer 410 with a deep trench leaving a portion 401 that extends towards the fiber array lid by a distance or gap. The substrate can form a deep trench structure based on the deep trench and extending portion. The deep trench structure forms an optical interface for edge coupling. The wafer substrate can also include a silicon oxide layer 412 positioned above the wafer substrate.

In an aspect, the wafer substrate may be termed as an edge coupler. Thus, the edge coupler can comprise the silicon oxide layer 412, the Si substrate layer 410 and the portion 401 of the Si Substrate layer that extends towards the fiber array lid by a distance.

In an aspect, the depth of the trench of layer 410 can be about 120 μm and the gap distance of the horizontally extending portion 401 to the front end of the fiber array can be about 20 to 40 μm assuming no lid is remaining at the front end. The silicon oxide layer 412 can be of a thickness of about 5 to 6 μm.

In this regard, an edge-coupled photonic integrated circuit (PIC) can be provided. The PIC can include a wafer substrate 410; and a fiber array 400 in-plane coupled with the wafer substrate and having an optical fiber core surrounded with a fiber cladding 404, the fiber array v-groove 406 can mount at the top of the fiber cladding 404 and a polished and tapered lid at the bottom of the fiber cladding 404.

In one aspect, a hybrid integration approach is preferred i.e., V-groove arrays are fabricated on separate silicon sub-mounts and are then edge coupled to the wafer substrate by active alignment. Since silicon V-grooves accurately position multiple fibers in a one-dimensional array with sub-micron precision, simultaneous active alignment of multiple fibers is enabled.

In an aspect, the core-clad concentricity can be <0.5 μm and the thickness of the cladding 404 and fiber core 402 can be about 125+/-0.7 μm.

In an aspect, the fiber core 402 thickness can be about 8-10 μm and the thickness of the fiber array V-groove 406 can be about 500 μm to 1 mm.

In an aspect, the thickness of the fiber array lid 408 may be 200-300 μm and the polishing may be done up to the edge of the cladding layer 404 above said lid.

In an embodiment, an integrated circuit structure is provided. The integrated structure includes a substrate, a deep trench structure in the substrate; and a fiber array lid 408 is aligned above the deep trench structure, the alignment including an angle and position of the fiber array lid, wherein the angle of the fiber array lid is predetermined by the depth of the deep trench structure, and wherein the position of the fiber array lid is controlled by the horizontally extending bottom portion of the deep trench structure. The circuit further includes a fiber core disposed between two cladding structures, wherein the cladding structure is disposed on top of the fiber array lid. The circuit further includes a fiber array groove 406 disposed on the cladding structure and the fiber array groove is of V-shape.

In an aspect, a method of manufacturing a photonic integrated circuit is provided. The method comprising a step of etching a silicon substrate of the wafer substrate to form the deep trench structure, wherein the deep trench structure forms the optical interface for edge coupling; a step of performing a first polishing of a fiber array lid 408 to align the fiber array lid 408 with the silicon substrate, whereby the fiber array lid 408 is aligned above the deep trench structure, wherein the first polishing forms the polished and tapered fiber array lid aligned with the wafer substrate and above the deep trench structure; and a step of performing a second polishing of the above polished and tapered fiber array lid to place the polished and tapered fibre array lid in proximity with the silicon oxide substrate. The above steps are performed to control an angle and front-end lid remnant of the polished and tapered fiber array lid arrangement. In an example the fiber core 402 is in proximity with the silicon oxide 412. The “proximity” can refer to a space or gap there between. In one embodiment, the said gap may be zero. The angle of fiber array lid is in between about 30° to 45°. The key target of fiber array front end and lid polishing is to ensure the fiber core 402 in proximity with Silicon Oxide 412 which ensure a good optical interconnect between fiber array and PIC.

It will be appreciated that variations of the above disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

1. A fiber array for edge coupling of at least one optical fiber with at least one wafer substrate at an edge of the fiber array, the fiber array comprising:
an optical fiber core;
a fiber cladding having an edge, a top and a bottom, and covering the optical fiber core;
a V-groove mount at the top of the fiber cladding; and
a fiber array lid at the bottom of the fiber cladding;
wherein the fiber cladding has a uniform cross section adjacent the edge, and the fiber array lid has a taper adjacent the edge.

2. The fiber array of claim 1, wherein the optical fiber core is single mode optical fiber core also has a uniform cross section adjacent the edge of the fiber cladding.

3. The fiber array of claim 1, wherein the fiber array lid comprises a polymer.

4. The fiber array of claim 1, wherein an angle of the taper of the fiber array lid is 30° to 45°.

5. A photonic integrated circuit comprising:
a wafer substrate;
a fiber array according to claim 1 in-plane and coupled with the wafer substrate.

6. The photonic integrated circuit of claim 5, wherein the optical fiber core is single mode.

7. The photonic integrated circuit of claim 5, wherein the optical fiber core is multimode.

8. The photonic integrated circuit of claim 5, wherein an angle of the taper of the fiber array lid is 30° to 45°.

9. The photonic integrated circuit of claim 6, wherein V-groove arrays are fabricated on separate silicon sub-mounts and are then edge coupled to the wafer substrate by active alignment.

10. The photonic integrated circuit of claim 5, wherein the wafer substrate comprises a deep trench structure, and the fiber array is aligned above the deep trench structure, the alignment including angle and position of the fiber array lid, wherein the angle of the fiber array lid is predetermined by a depth of the deep trench structure.

11. A method of manufacturing the photonic integrated circuit of claim 10, the method comprising;
a) a step of etching a silicon substrate of the wafer substrate to form a deep trench structure such that the deep trench structure forms an optical interface for edge coupling;
b) a step of performing a first polishing of the fiber array lid to form a polished fiber array lid aligned with the wafer substrate and above the deep trench structure;
c) a step of performing a second polishing of the polished fiber array lid to place a further polished fiber array lid in proximity with a silicon oxide substrate; and
d) the fiber core is adjusted in proximity with the silicon oxide to achieve a good optical interconnection between the fiber array and the wafer substrate.

12. The method of claim 11, wherein an angle of the taper of the further polished fiber array lid is 30° to 45°.
